(19) United States
(12) Patent Application Publication
(10) Pub. No.: US 2015/0008264 A1
(43) Pub. Date: Jan. 8, 2015

(54) MOBILE HEATING UNIT WHICH IS OPERATED BY WAY OF LIQUID FUEL

(71) Applicant: WEBASTO SE, Stockdorf (DE)

(72) Inventors: Volodymyr Ilchenko, Gilching (DE); Vitali Dell, Munich (DE)

(21) Appl. No.: 14/379,951

(22) PCT Filed: Feb. 22, 2013
(86) PCT No.: PCT/DE2013/100070

§ 371 Date: Aug. 20, 2014

(30) Foreign Application Priority Data
Feb. 27, 2012 (DE) 10 2012 101 578.3

(51) Int. Cl. B60H 1/22

(52) U.S. Cl. CPC B60H 1/2212
USPC 237/12.3 C; 432/223

(57) ABSTRACT

A mobile heating device operated with liquid fuel is provided, having: a combustion chamber (2) comprising a combustion air inlet (3), wherein the combustion chamber (2) adjacent to the combustion air inlet (3) comprises a widening portion (20) the cross-section of which widens with increasing distance from the combustion air inlet (3) and in which in operation combustion air and fuel are converted in a flaming combustion; a fuel supply which is arranged such that fuel is supplied into the widening portion (20); and an air guide device (6) being adapted to feed combustion air into the widening portion (20) with a flow component directed in the circumferential direction such that an axial recirculation region forms in the widening portion (20) in which gases flow in the direction towards the combustion air inlet (3) oppositely to a main flow direction (H). The fuel supply comprises an injector nozzle (15) for injecting fuel at the combustion air inlet (3).

The present invention relates to a mobile heating device operated with liquid fuel.

In the present context, a “mobile heating device” is to be understood as a heating device which is adapted for use in mobile applications and designed accordingly. This means in particular that it is transportable (fixedly mounted in a vehicle or only arranged therein for transport, as the case may be) and not exclusively adapted for continuous, stationary use, as is the case in the heating of a building. The mobile heating device may also be fixedly installed in a vehicle (land vehicle, boat, etc.), in particular in a land vehicle. In particular, it can be adapted for heating a vehicle interior, such as for instance of a land vehicle, boat, or aircraft, and a partly open room, as can be found for example on boats, in particular on yachts. The mobile heating device can also temporarily be used stationary, such as for example in big tents, containers (e.g. containers for construction sites), etc. According to a preferred further development, the mobile heating device is adapted as a parking heater or auxiliary heater for a land vehicle, such as for example for a mobile home, a caravan, a bus, a car, etc.

Mobile heating devices often are used e.g. as vehicle heating devices for heating a vehicle. In applications in a vehicle, such mobile heating devices are e.g. employed as auxiliary heaters which can provide additional heat when the propulsion engine of the vehicle is running or as parking heaters which can provide heat for heating purposes both when the propulsion engine is running and when it is at rest. In such mobile heating devices it is required that these shall, on the one hand, be operable with low heating power down to below 1 kW and, on the other hand, shall comprise a band width of heating powers being as large as possible, such that very different heating powers can be provided depending on the demand. In particular, for some applications also large heating powers above 15 kW or above 20 kW are desired.

Usually, in mobile heating devices burners are used which are provided in a combustion chamber with components for flame stabilization, such as in particular constrictions, neckings or other components reaching into the region of the flame and of the hot gases flowing away, in order to enable as much as possible stable operation at different heating powers. Such components are subjected to particularly high loads during operation of the mobile heating device and often form those components which restrict the lifetime of the heating device.

It is an object of the present invention to provide an improved mobile heating device operated with liquid fuel.

The object is solved by a mobile heating device operated with liquid fuel according to claim 1. Advantageous further developments are defined in the dependent claims.

The mobile heating device comprises: a combustion chamber comprising a combustion air inlet, wherein the combustion chamber adjacent to the combustion air inlet comprises at least a widening portion the cross-section of which widens with increasing distance from the combustion air inlet and in which in operation combustion air and fuel are converted in a flaming combustion; a fuel supply which is arranged such that fuel is supplied into the widening portion; and an air guide device being adapted to feed combustion air into the widening portion with a flow component directed in the circumferential direction such that an axial recirculation region forms in the widening portion in which gases flow in the direction towards the combustion air inlet oppositely to a main flow direction. The fuel supply comprises an injector nozzle for injecting fuel at the combustion air inlet.

In the present context, a combustion chamber has to be understood as a region of the heating device in which flaming conversion of fuel and combustion air takes place. In particular, in the context of the present description the term combustion chamber does not mean the wall surrounding this region which can e.g. be formed by a plurality of components. Flaming combustion takes place at least also in the widening portion and not only in a region of the combustion chamber situated further downstream. By the air guide device which provides the air entering at the combustion air inlet so strongly with a flow component directed in the circumferential direction (i.e. with a strong swirl) that an axial recirculation region forms in the widening portion in which gases flow in the direction towards the combustion air inlet oppositely to the main flow direction, combustion which is low in emissions and stable is achieved with which operation over a large bandwidth of heating powers is enabled without requiring additional flame-stabilizing components protruding into the combustion chamber. Due to the defined geometric design and to the formation of the recirculation region it is achieved that the flame always spreads out stably starting from the widening portion also at different heating powers, i.e. different flow rates of fuel and combustion air. In this manner, the flame stabilizes itself in the combustion chamber. Formation of the recirculation region can easily be achieved by the widening portion widening strong enough, e.g. with a half cone angle of at least 20°, and by the supplied combustion air being provided with a sufficiently large flow component directed in the circumferential direction, in particular with a swirl factor of at least 0.6. Since the injector nozzle is provided for injecting fuel at the combustion air inlet, also large heating powers above 15 kW, in particular above 20 kW, can be reliably provided with the mobile heating device.

According to a further development, the injector nozzle is arranged with respect to an axial direction of the heating device such that the fuel is supplied at the combustion air inlet radially inside the combustion air. In this case, a particularly symmetric construction of the burner of the mobile heating device is enabled and a radially outer region is available for other components.

According to a further development, the fuel supply comprises at least one evaporator element for evaporating liquid fuel. In contrast to a fuel supply which only possesses an injector nozzle for injecting the fuel, use of the evaporator element enables stable operation of the mobile heating device also at low heating powers below 1 kW, i.e. low flow rates of fuel and combustion air. Further, in this manner stable operation is enabled even in the case of formation of air bubbles in a fuel supply line because the evaporator element acts as a buffer. Furthermore, the evaporator element permits use of different liquid fuels, since effects due to different boiling temperatures and evaporation enthalpies are attenuated by the evaporator element. By the combination of injector nozzle and evaporator element, a large bandwidth of possible heating powers is achieved. Further, in the case of e.g. a short interruption of the fuel supply to the injector nozzle, which can e.g. occur due to air bubbles, extinguishing of the flame can reliably be prevented by the fuel-storing evaporator element which can still provide fuel. Preferably, the evaporator element is arranged such that fuel exiting from the evaporator element is supplied into the widening portion at the combustion air inlet, since in this case particularly preferred pre-mixing of fuel and combustion air takes place in the region of the widening portion arranged at the combustion air inlet.

According to a further development, a fuel line for supplying fuel to the evaporator element is provided. In this case, the evaporator element can reliably be supplied with fuel such that, e.g. for providing small heating powers, operation is possible in which fuel is only supplied via the evaporator element.

According to a further development, the at least one evaporator element is arranged such that it at least partially surrounds the combustion air inlet. In this case, symmetric supply of evaporated fuel is achieved such that particularly homogeneous mixing of combustion air and fuel is attained which enables combustion with low emissions. If the at least one evaporator element ring-shaped surrounds the combustion air inlet, particularly symmetric supply of evaporated fuel is enabled.

According to a further development, the at least one evaporator element is thermally coupled to the widening portion. In this case, the evaporation process of liquid fuel in and on the evaporator element can be maintained by heat from the flame in the widening portion. Due to the given design of the combustion chamber, more heat for evaporating fuel is supplied to the evaporator element at higher heating power, when a higher flow rate of fuel is required, and correspondingly less heat at a lower heating power, i.e. a lower flow rate of fuel. At even larger heating powers, the required mass flow of fuel can reliably be maintained by the injector nozzle. The evaporator element can e.g. be covered in the direction towards the combustion chamber by a cover, preferably a metal sheet, which forms the wall of the widening portion. Heat transfer to the evaporator element can be effected by thermal conduction via the metal sheet. Due to the given design of the combustion chamber which results in reliable anchoring of the flame in the widening portion, heat transfer from the flame into the wall of the widening portion takes place reliably also at different heating powers. This heat transfer takes mainly place via convection. Since vortices form at the wall of the widening portion due to the design of the combustion chamber, the heat transfer to the evaporator element necessary for evaporation reliably takes place over a large bandwidth in particular at low heating powers.

According to a further development, the evaporator element is partly covered by a cover such that a fuel discharge portion is formed in a region which is not covered. In this case it can be reliably achieved that liquid fuel is evenly distributed in the evaporator element such that the whole evaporator element is used for evaporation of fuel and formation of deposits in the evaporator element is suppressed. Preferably, supply of liquid fuel to the evaporator element is effected in a region of the evaporator element which is far away from the fuel discharge portion and in which the evaporator element is covered by the cover. If the cover forms a wall of the widening portion, the resulting heat input into the evaporator element can be adjusted in a simple way by appropriate construction of the cover, in particular with regard to material and wall thickness.

If the fuel discharge portion is arranged at the combustion air inlet, particularly reliable mixing of combustion air and evaporated fuel can take place.

According to a further development, the evaporator element is arranged such that evaporated fuel exits with a directional component which is directed opposite to the main flow direction. In this case, particularly effective mixing of combustion air and fuel is achieved immediately at the combustion air inlet. The fuel can also comprise other directional components during exit, in particular a radial directional component in a direction towards a longitudinal axis of the combustion chamber.

According to a further development, the widening portion comprises a continuously widening cross-section. It can in particular be formed as conically widening. By the design with a continuously widening cross-section, undesired corner eddies can be prevented which would form in the case of a step-like widening cross-section. In particular the swirl current of the fuel-combustion air-mixture can reliably be held at the wall of the widening portion.

According to a further development, the widening portion widens with an opening angle of at least 20°. In this case, a construction of the widening portion is provided which acts as a discontinuous widening of the flow cross-section from the point of view of fluid dynamics. In combination with the supply of combustion air with the flow component directed in the circumferential direction, reliable flame anchoring in the widening portion is achieved also at different heating powers.

According to a further development, the air guide device is formed such that the combustion air is supplied into the widening portion with a swirl factor of at least 0.6. The swirl factor (S_{N}) is an integral value which defines the relation of the tangential flow momentum to the axial flow momentum. With a swirl factor of at least 0.6, a fully formed recirculation zone is reliably attained. Preferably, the mobile beating device can be adapted such that the combustion air is supplied into the combustion air inlet with flow velocities being higher than the turbulent flame velocities arising in the combustion chamber. In this case, it is reliably ensured that no flame can form immediately at the combustion air inlet such that burning-back of the flame to the fuel supply is prevented. Furthermore, it is achieved in this manner that efficient pre-mixing of fuel and combustion air takes place in the region of the widening portion situated close to the combustion air inlet in which a flame cannot form.

According to a further development, the combustion chamber continuously has a free flow cross-section. A continuously free flow cross-section means that no components hindering a flow in the axial direction of the combustion chamber, such as e.g. flame baffles, constrictions or the like, are provided. In this case, no components are provided in the combustion chamber which in conventional heating devices often reduce the lifetime due to the high load during operation, such that a mobile heating device having a long lifetime can be provided. It has to be noted that components necessary for operation, such as in particular ignition elements and/or sensors, having only negligible influence on the flow may protrude into the combustion chamber, as the case may be. Preferably, the combustion chamber—adjacent to the widening portion—can have a portion with across-section remaining substantially constant. In this case, the flow characteristics in the combustion chamber are particularly advantageously adjustable. The portion having a cross-section remaining substantially constant can in particular be formed by an at least substantially hollow-cylindrical combustion chamber wall.

Further advantages and further developments will become apparent from the following description of embodiments with reference to the enclosed drawings.

FIG. 1 is a schematic sectional illustration of the burner of a mobile heating device according to a first embodiment;

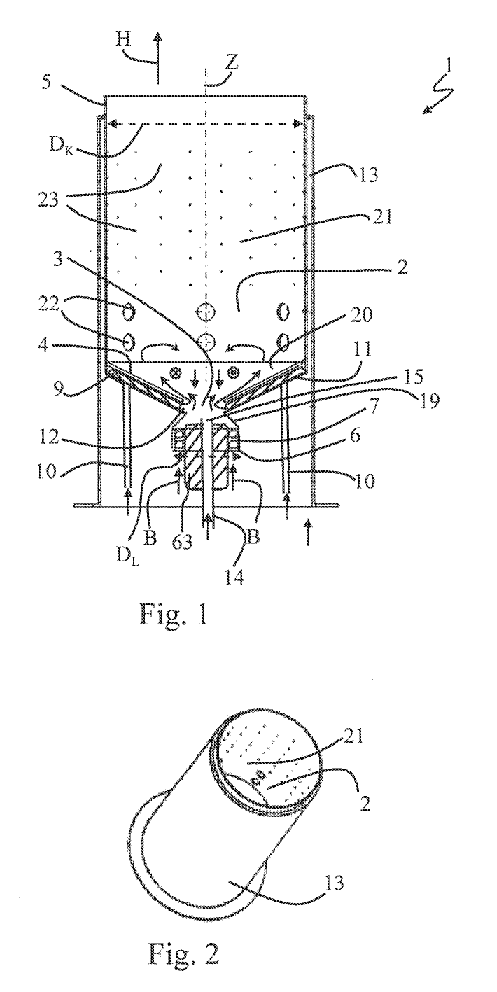

FIG. 2 is a schematic perspective illustration of the burner from FIG. 1;

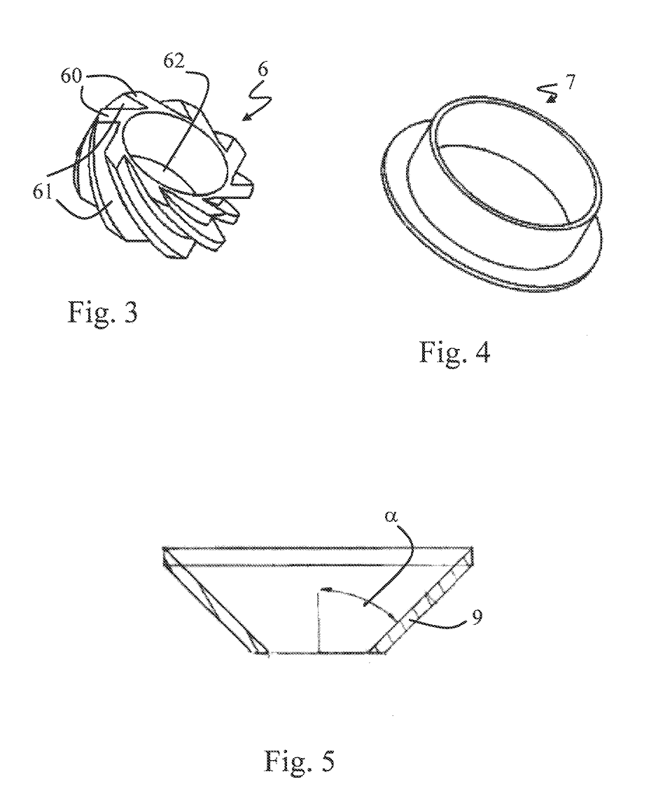

FIG. 3 is a schematic perspective illustration of an air guide device in the burner from FIG. 1;

FIG. 4 is a schematic illustration of a housing surrounding the air guide device depicted in FIG. 3;

FIG. 5 is a schematic illustration of an evaporator element in the first embodiment;

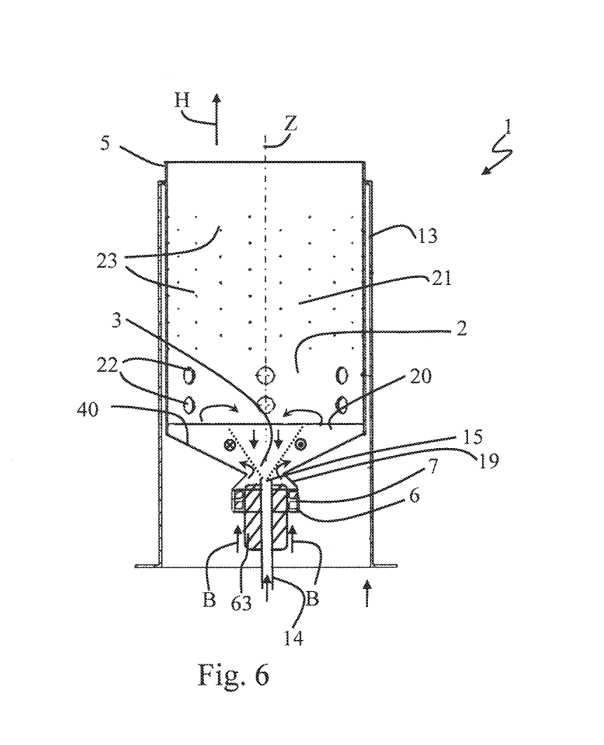

FIG. 6 is a schematic sectional illustration of the burner of a mobile heating device according to a second embodiment; and

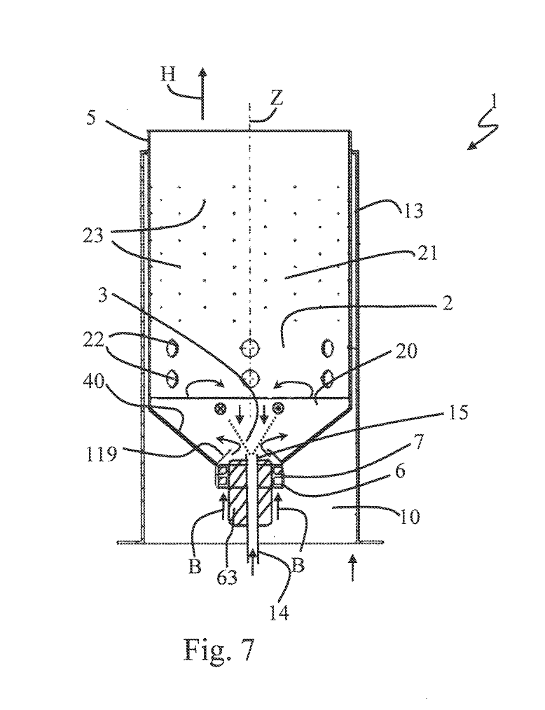

FIG. 7 is a schematic sectional illustration of the burner of a mobile heating device according to a third embodiment.

### FIRST EMBODIMENT

A first embodiment will be described in the following with reference to FIGS. 1 to 5.

In the first embodiment, the mobile heating device operated with liquid fuel is in particular formed as a parking heater or auxiliary heater for a vehicle, in particular for a land vehicle. In the figures, only the burner 1 of the mobile heating device is illustrated. Further to the illustrated burner 1, the mobile heating device comprises in particular in a per se known manner a heat exchanger for transferring heat to a medium to he heated, such as in particular a liquid in a liquid circuit of a vehicle or air to be heated. The heat exchanger can for example cup-like surround the burner 1 in a per se known manner. Further, the mobile heating device comprises at least one fuel supply device, which can in particular be formed by a fuel pump; a combustion air conveying device, which can e.g. comprise a combustion air blower; and at least one control unit for controlling the mobile heating device.

In the following, the burner 1 of the mobile heating device will be described more in detail with reference to FIGS. 1 to 5. The burner 1 comprises a combustion chamber 2 in which fuel and combustion air are converted in a flaming combustion during operation of the mobile heating device. In FIG. 1, the burner 1 is illustrated in a schematic sectional illustration, wherein the sectional plane is chosen such that a longitudinal axis Z of the burner 1 lies in the sectional plane. The burner 1 is formed substantially rotationally symmetric with regard to the longitudinal axis Z. The combustion chamber 2 comprises a combustion air inlet 3 at which combustion air is supplied into the combustion chamber 2 during operation.

Immediately adjacent to the combustion air inlet 3, the combustion chamber 2 comprises a widening portion 20 the cross-section of which widens with increasing distance from the combustion air inlet 3. In the depicted embodiment, the widening portion is confined by a conical wall which is formed by a cover 4 which will be described more in detail below. In a main flow direction H, a substantially cylinder-jacket-shaped wall 5 adjoins the conical wall of the widening portion 20, such that the combustion chamber 2 comprises a portion 21 having a cross-section remaining substantially constant adjacent to the widening portion 20. The size relations are chosen such that the diameter relation V between the outer diameter D_{L} of the air guide device 6 and the diameter D_{K} of the portion 21 of the combustion chamber 2 is smaller or equal to 0.5 (V=D_{L}/D_{K} and V≦0.5).

The widening portion 20 widens with an opening angle of at least 20°. The opening angle is the angle which is formed between the wall of the widening portion 20 and the longitudinal axis Z. In the depicted embodiment, the opening angle amounts to e.g. between 60° and 70°. The combustion chamber 2 comprises an overall free flow cross-section so that no components hindering a free flow of gases protrude laterally into the combustion chamber 2 such that the gas flows in the combustion chamber 2 can develop according to the geometry of the widening portion 20 and of the adjacent portion 21, as will be described more in detail below.

In front of the combustion air inlet 3, an air guide device 6 is provided which is adapted in order to introduce the combustion air into the widening portion with a flow component directed in the circumferential direction. The air guide device 6 is formed such that a very large swirl is impressed onto the combustion air. The air guide device 6 is formed such that the air is introduced into the combustion air inlet 3 with a swirl factor of at least 0.6. The burner 1 is adapted such that a decrease in pressure in a range between 2 mbar and 20 mbar occurs over the air guide device 6. The air guide device 6 will be described more in detail With reference to FIGS. 3 and 4.

In the first embodiment, the air guide device 6 comprises an approximately ring-shaped shape and is provided on the outside with spirally extending guide blades 60 between which also spirally extending channels 61 are formed. In the mobile heating device according to the embodiment, the air guide device 6 is inserted in a substantially hollow-cylindrical casing 7, which is illustrated in FIG. 4. The air guide device 6 is inserted in the casing 7 such that the spirally extending channels 61 are circumferentially closed by the casing 7. Thus, the spirally extending channels 61 are only open at their two face sides such that combustion air can pass through. In FIG. 3 it is illustrated that the air guide device 6 is provided with a central cylindrical through-bore 62. In the illustrated first embodiment, in the assembled state of the burner 1 the through-bore 62 is however closed by a plug 63 which is provided with a small bore through which a fuel line 14 is passed at the end of which an injector nozzle 15 is situated, as illustrated in FIG. 1.

In the first embodiment, the air guide device 6 is arranged such that combustion air at one face side enters into the channels 61 closed by the casing 7, flows through the spirally extending channels 61, and at its other face side is introduced into a tapering portion 19 situated in front of the combustion air inlet 3. In the first embodiment, the tapering portion 19 is formed by a narrowing truncated cone. The combustion air is impressed with a swirl by the spirally-shaped design of the channels 61. The channels 61 are formed such that the combustion air is impressed with the required swirl factor of at least 0.6. As schematically illustrated in by arrows B in FIG. 1, the combustion air is supplied to the air guide device 6 by a combustion air conveying device (not shown) which can e.g. comprise a blower.

Due to the described design of the air guide device 6, of the tapering portion 19, and of the following combustion air inlet 3 to the widening portion 20, the combustion air is introduced at the combustion air inlet 3 into the widening portion 20 with a flow component directed in the circumferential direction.

As schematically depicted by arrows in FIG. 1, fuel can be injected into the widening portion 20 of the combustion chamber 2 at the combustion air inlet 3 by the injector nozzle 15 which is supplied with liquid fuel via a fuel conveying device (not shown) and the fuel line 14. In the embodiment, the injector nozzle 15 is formed as an atomizing nozzle. The injector nozzle 15 is formed such that the fuel is discharged from the injector nozzle 15 into the widening portion 20 substantially hollow-cone-shaped. The opening angle of the hollow cone with which the atomized fuel exits from the atomizing nozzle is preferably selected such that the fuel enters the shear flow region which forms between the gases flowing off at the wall of the widening portion 20 and the gases flowing back in the axial recirculation region. In the illustrated embodiment, the opening angle of the hollow cone with which the atomized fuel is supplied amounts to between 20° and 40°, preferably between 25° and 35°. The opening angle means the angle between the exiting atomized fuel and the longitudinal axis Z. The ejector nozzle 15 is axially arranged such that the fuel is supplied axially inside the of the combustion air exiting from the air guide device 6. In this manner, cooling of the injector nozzle 15 through the supplied combustion air takes place. Heat from the injector nozzle 15 is transferred to the combustion air flowing through the channels 61 via the guide blades 60 acting also as heat exchanger. After exiting from the air guide device 6, the combustion air is forced by the tapering portion 19 to flow around the discharge region of the injector nozzle 15 and to further cool it. Further it is achieved in this manner that hot gases from the combustion process in the combustion chamber 2 which are flowing back cannot reach the injector nozzle 15. The narrowing of the cross-section further effects an increase in the tangential velocity component of the through-passing combustion air and brings the axial velocity component closer to the longitudinal axis Z.

The mobile heating device is designed for operation with liquid fuel and can e.g. be operable with fuel which is also used for a combustion engine of a vehicle, in particular diesel, benzine and/or ethanol. In the embodiment, in addition to the described injector nozzle 15 the fuel supply comprises a further device for supplying fuel, which will be described more in detail in the following.

In the first embodiment, the fuel supply comprises at least one evaporator element 9 for evaporating supplied liquid fuel via which fuel can also be supplied into the widening portion 20 at the combustion air inlet 3, as schematically illustrated by arrows in FIG. 1.

In the first embodiment, the evaporator element 9 has the shape of a truncated hollow cone, as can be seen in FIG. 5. The evaporator element 9 comprises an opening angle α which corresponds to the opening angle of the widening portion 20. The evaporator element 9 is formed from a porous and heat-resistant material and can in particular comprise metal non-woven fabric, metal network and/or metal woven fabric. As illustrated in FIG. 1, a plurality of fuel lines 10 for supplying liquid fuel to the evaporator element 9 is provided. Although exemplarily two fuel lines 10 are illustrated in FIG. 1, also e.g. only one fuel line 10 can be provided or more fuel lines 10 can be provided. A plurality of fuel lines 10 for supplying liquid fuel to the evaporator element has the advantage that more even exploitation of the evaporator element 9 is enabled.

At a side facing away from the combustion chamber 2, the evaporator element 9 is covered by a rear wall 11 through which the fuel lines 10 are passed through. At the side facing the combustion chamber 2, the evaporator element 9 is covered by the cover 4 already described before which can in particular be formed from a metal sheet. The evaporator element 9 is arranged such that it ring-shaped surrounds the combustion air inlet 3. At the combustion air inlet 3, the evaporator element 9 comprises an uncovered fuel discharge portion 12 at which evaporated fuel can exit from the evaporator element 9. The other sides of the evaporator element 9 are—except for the fuel lines 10—each covered such that fuel can only exit from the evaporator element 9 at the fuel discharge portion 12. The fuel discharge portion 12 ring-shaped surrounds the combustion air inlet 3 so that fuel can be evenly supplied from all sides. It has to noted that the evaporator element 9 does not necessarily need to have a closed ring shape and that also several separate evaporator elements 9 can be arranged distributed over the circumference, as the case may be. The evaporator element 9 is thermally coupled to the widening portion 20 via the cover 4 such that, in operation of the mobile heating device, heat is transferred into the evaporator element 9 from the flame anchored in the widening portion 20 in order to provide the evaporation heat necessary for fuel evaporation there. An ignition element for starting the burner which at least partially protrudes into the combustion chamber and which is not depicted in FIG. 1 for reasons of simplicity can further be provided.

By arrangement of the evaporator element 9 in the described manner in which the fuel lines 10 are spatially spaced from the fuel discharge portion 12, even dispersion of the supplied liquid fuel in the evaporator element 9 is achieved such that the whole evaporator element 9 is utilized for fuel evaporation. By the described arrangement in which the outlets of the fuel lines are arranged more downstream in the main flow direction H than the fuel discharge portion 12, it is further achieved that the fuel exits from the evaporator element 9 with a directional component which is directed opposite to the main flow direction H. In this manner, a particularly homogeneous mixing of the exiting fuel with the combustion air exiting from the air guide device 6 is attained such that good mixing of combustion air and evaporated fuel is attained immediately at the combustion air inlet 3. Further pre-mixing of fuel and combustion air takes place in the first region of the widening portion in which no flame forms.

The components of the burner 1 described above are surrounded at the outside by a substantially hollow cylindrical burner flange 13 which forms a flow space for supplied combustion air. The burner flange 13 further serves for fixation of the burner to further components of the mobile heating device situated at the rear side which are not illustrated. The burner flange 13 is formed such that a ring-shaped slit is formed between the inner side of the burner flange 13 and the outer side of the portion 21 of the combustion chamber wall which is adjacent to the widening portion 20, through which slit a part of the supplied combustion air can flow. At a downstream end with respect to the main flow direction H, the burner flange 13 is connected to the portion 21 such that the slit is closed there. As can be seen in FIGS. 1 and 2, the portion 21 of the combustion chamber wall adjacent to the widening portion 20 comprises a plurality of holes 22 and 23 through which combustion air can also enter into the combustion chamber 2. Due to the chosen geometry, the combustion air supplied by the combustion air conveying device is divided in a predetermined relation such that a part of the combustion air is supplied into the widening portion 20 via the air guide device 6 at the combustion air inlet 3 and another part of the combustion air is supplied into the combustion chamber via the slit and the holes 22 and 23.

Operation of the burner 1 over a large bandwidth of different heating powers is enabled by the described design. Operation at low heating power can be provided by supplying fuel only via the evaporator element 9 and injecting no fuel into the combustion chamber 2 via the injector nozzle 15. For achieving high heating powers, fuel is injected into the widening portion 20 via the injector nozzle 15. Also during operation at high heating power preferably additionally to the supply of fuel via the injector nozzle 15 fuel can also be supplied to the combustion air inlet 3 via the evaporator element 9. In this case, extinguishing of the flame in the combustion chamber 2 can be prevented with the fuel supplied via the evaporator element 9 in the case of e.g. a short interruption of the supply of fuel to the injector nozzle, which can e.g. occur due to formation of air bubbles.

By the described design of the burner 1, further stable anchoring of the flame in the widening portion 20 is achieved over a large bandwidth of heating powers, as will be described more in detail in the following.

The combustion air exiting from the air guide device 6 comprises a large swirl and the tangential directional component is further increased in the tapering portion 19. Subsequently, the combustion air is mixed at the combustion air inlet 3 with the fuel exiting there from the evaporator element 9 and/or from the injector nozzle 15. Due to the strong swirl of the combustion air in combination with the strong widening of the widening portion 20, the current of the combustion air-fuel-mixture remains resting against the wall of the widening portion 20 due to acting centrifugal forces. Formation of thus-called dead water zones on the outer side at the wall can reliably be prevented even in the case of a strong widening. The current flows along the wall of the widening portion 20 with relatively high velocities such that during operation of the burner good convective heat transfer to the cover 4 and—via thermal conduction—to the evaporator element 9 placed behind it takes place.

From the point of view of fluid dynamics, the design of the widening portion 20 acts liken discontinuous widening of the cross-section such that with the swirling current a strong widening of the core swirl occurs in the widening portion 20. Due to the resulting local static pressures, subsequent to the widening of the core swirl a break-down of the core swirl occurs such that a strong back current opposite to the main flow direction H forms in a radially inner region close to the longitudinal axis Z, as schematically depicted by arrows in FIG. 1. With the described geometric design of the burner 1, the recirculation vortices forming in this manner have a position which is substantially independent from the mass flow of the combustion air-fuel-mixture such that self-stabilization or anchoring of the flame in the widening portion 20 takes place. Formation of these flow characteristics can be explained by the fact that the swirling current radially widens in the widening portion 20 wherein deceleration in the axial direction occurs. The tangential directional component of the velocity effects a radial pressure gradient whereby the static pressure decreases in the direction towards the longitudinal axis Z. Due to these pressure conditions, the recirculation region forms.

Due to the described design, the burner 1 can be operated over a large bandwidth of different heating powers, in particular in a power range from approximately 0.8 kW up to far above 20 kW.

The combination of the combustion chamber design and the evaporator element 9 enables stable operation also at relatively low heating powers. By the evaporator element 9, stable supply of fuel into the combustion chamber 2 takes place even if air bubbles should form in the fuel line 10 or in the fuel line 14. Due to the resulting self-stabilization or anchoring of the flame in the widening portion 20, higher heat input into the evaporator element 9 takes place at higher heating powers such that a larger amount of fuel per time can reliably be evaporated there. At a lower heating power, correspondingly smaller heat input takes place such that the process of fuel evaporation can also reliably be maintained to the desired extent over a large bandwidth of heating powers. If a very high heating power shall be provided, a large mass now of fuel can reliably be maintained via the injector nozzle 15. By the achieved flowing-through of substantially the whole volume of the evaporator element 9, it is reliably acted against formation of residues in the evaporator element 9.

Since a well-defined, good mixing of fuel and combustion air is attained with the described design, a combustion which is very low in emissions is achieved. In the described mobile heating device, the combustion air is introduced into the widening portion 20 with a high flow velocity. In this manner, undesired back-burning can reliably be prevented. Further, pre-mixing of fuel and combustion air in the region of the widening portion 20 adjacent to the combustion air inlet 3 is achieved which contributes to a combustion process being particularly low in emissions.

### SECOND EMBODIMENT

A second embodiment will be described in the following with reference to FIG. 6, wherein only the differences to the first embodiment will be described more in detail in order to avoid repeating and the same reference signs as in the first embodiment are used for the same elements or components.

The second embodiment differs from the first embodiment in that the fuel supply in contrast to the first embodiment comprises only the ejector nozzle 15 for supplying fuel into the widening portion 20, and not also an evaporator element 9. Also in the second embodiment, the widening portion 20 comprises across-section which widens with increasing distance from the combustion air inlet 3. Also in the second embodiment, the widening portion 20 is confined by a conical wall which however, in contrast to the first embodiment, is not formed by a separate cover 4 but by a rear wall 40 of the combustion chamber 2.

In the further features, the second embodiment fully corresponds to the first embodiment described above such that a repeated detailed description of these further features is omitted.

### THIRD EMBODIMENT

A third embodiment is schematically illustrated in FIG. 7. In order to avoid repeating, only the differences to the second embodiment will be described more in detail and the same reference signs as in the first and second embodiments are used for the same elements or components.

The third embodiment differs from the second embodiment substantially only in the arrangement of the tapering portion relative to the air guide device 6 and to the widening portion 20. In the third embodiment, instead of the tapering portion 19 a tapering portion 119 is provided which is moved into the most upstream situated region of the widening portion 20 such that the combustion air inlet 3 is not situated immediately at the inlet-side end of the widening portion 20 but the wall of the tapering portion 119 protrudes slightly into the widening portion 20. Also in the third embodiment, le tapering portion 119 comprises a substantially hollow-cone-shaped construction.

Also in this third embodiment, a strong radial widening of the combustion air swirl occurs in the region of the combustion air inlet 3 which results in the formation of the axial recirculation region close to the longitudinal axis Z, as has been described in detail with regard to the first embodiment. The construction according to the third embodiment enables a particularly compact arrangement of air guide device 6, injection nozzle 15, and widening portion 20.

Although a third embodiment has been described in which no additional evaporator element 9 is provided, it is for example also possible to provide an evaporator element 9 in the third embodiment, as has been described with reference to the first embodiment.

1. A mobile heating device operated with liquid fuel, said mobile heating device comprising:
a combustion chamber having a widening portion and in which in operation combustion air and fuel are converted in a flaming combustion;
a combustion air inlet adjacent the combustion chamber, the widening portion having a cross-section which widens with increasing distance from the combustion air inlet;
a fuel supply supplying fuel into the widening portion, the fuel supply including an injector nozzle injecting fuel at the combustion air inlet; and
an air guide guiding combustion air into the widening portion with a flow component directing the combustion air in a circumferential direction such that an axial recirculation region forms in the widening portion in which gases flow in a direction towards the combustion air inlet oppositely to a main flow direction.

2. The mobile heating device according to claim 1, in which the injector nozzle is arranged with respect to an axial direction of the heating device such that the fuel is supplied at the combustion air inlet radially inside the combustion air.

3. The mobile heating device according to claim 1, in which the fuel supply includes at least one evaporator element for evaporating liquid fuel.

4. The mobile heating device according to claim 3, in which at least one fuel line supplies fuel to the evaporator element.

5. The mobile heating device according to claim 3, in which the at least one evaporator element at least partially surrounds the combustion air inlet.

6. The mobile heating device according to claim 3, in which the at least one evaporator element is ring-shaped and surrounds the combustion air inlet.

7. The mobile heating device according to claim 3, in which the at least one evaporator element is thermally coupled to the widening portion.

8. The mobile heating device according to claim 3, in which the evaporator element is partly covered by a cover such that a fuel discharge portion is formed in a region of the evaporator element that is not covered by the cover.

9. The mobile heating device according to claim 8, in which the fuel discharge portion is arranged at the combustion air inlet.

10. The mobile heating device according to claim 8, in which the cover forms a wall of the widening portion.

11. The mobile heating device according to claim 3, in which the evaporator element is arranged such that evaporated fuel exits the evaporator element with a directional component which is directed opposite to the main flow direction.

12. The mobile heating device according to claim 1, in which the widening portion includes a continuously widening cross-section.

13. The mobile heating device according to claim 1, in which the widening portion widens with an opening angle of at least 20°.

14. The mobile heating device according to claim 1, in which the air guide is formed such that the combustion air is supplied into the widening portion with a swirl factor of at least 0.6.

15. The mobile heating device according to claim 1, in which the combustion chamber continuously has a free flow cross-section.
